(19) United States
(12) Patent Application Publication
(10) Pub. No.: US 2007/0244237 A1
(43) Pub. Date: Oct. 18, 2007

(54) Soil-Resistant Thermoplastic Elastomer Compositions and Related Methods

(75) Inventor: Ashok M. Adur, Westlake, OH (US)

Correspondence Address: POLYONE CORPORATION, 33587 WALKER ROAD, AVON LAKE, OH, 44012, US

(73) Assignee: PolyOne Corporation, Avon Lake, OH (US)

(21) Appl. No.: 11/570,416

(22) PCT Filed: Jun. 27, 2005
(86) PCT No.: PCT/US05/22986

§ 371 Date: Dec. 11, 2006

Related U.S. Application Data
(60) Provisional application No. 60/585,022, filed on Jul. 2, 2004.

(51) Int. Cl. C08L 23/00

(52) U.S. Cl. 524/265; 523/1; 524/81; 524/856

(57) ABSTRACT

Disclosed are thermoplastic elastomer compositions, which are beneficially soil-resistant. The compositions comprise at least one elastomeric phase, at least one thermoplastic phase, and a minor amount of at least one low surface energy additive incorporated therein. Also disclosed are improved articles based on the compositions and the use of at least one low surface energy additive for modifying a thermoplastic elastomer to improve its soil resistance.

### CLAIM OF PRIORITY

This application claims priority from U.S. Provisional Patent Application Ser. No. 60/585,022 bearing Attorney Docket Number 12003015 and filed on Jul. 2, 2004.

### BACKGROUND OF THE INVENTION

This invention relates to thermoplastic elastomer compositions comprising a low surface energy additive for enhanced soil resistance of the composition.

In the past several decades, the use of polymers has transformed the world. Polymer science has rapidly evolved to make thousands of different thermoplastic and thermosetting products within the four corners of polymer physics: thermoplastic plastics, thermoplastic elastomers, thermoset plastics, and thermoset elastomers. Of these four, a thermoplastic elastomer (also “TPE”) exhibits both the valuable performance properties of an elastomer and the valuable processing properties of a thermoplastic.

Thermoplastic elastomers are generally identified and categorized, as reported in Thermoplastic Elastomers, edited by Holden et al. (1996), based on the type of elastomer. A “thermoplastic elastomer” (TPE) is generally a polymer or blend of polymers that can be processed and recycled in the same way as a conventional thermoplastic material, yet having properties and performance similar to that of an elastomer or rubber at the service temperature at which it is used. Notably, blends (or alloys) of plastic and elastomeric rubber have become increasingly important in the production of thermoplastic elastomers, particularly for the replacement of thermoset rubber or flexible polyvinyl chloride (PVC) in various applications.

A “thermoplastic vulcanizate” (TPV) is a type of thermoplastic elastomer, where the elastomer phase is partially or completely crosslinked, vulcanized or cured, such that the TPV can be processed and recycled in the same way as a conventional thermoplastic material, yet retaining properties and performance similar to that of a vulcanized elastomer or rubber at the service temperature at which it is used. TPVs are becoming increasingly important in the production of high performance thermoplastic elastomers, particularly for the replacement of thermoset rubber in various applications.

No large scale production of any polymer can rest on current processing conditions. Reduction of cost, improvement of productivity, and delivery of better performing, lower cost products all drive the polymer science industry. The situation is no different for TPEs, particularly those used for certain types of applications.

One such application is that where TPEs are subjected to environments containing various types of soil such as dirt, grease, and/or oil (e.g., body oil). For example, designers of TPEs for many consumer applications struggle with those and other undesirable conditions in the everlasting pursuit of improved TPEs and processes for the same.

Consumer applications involving, for example, household appliances and motorized vehicles (e.g., automobiles) are often used in environments where they are prone to soiling. One such household appliance is a refrigerator. Amongst other parts therein, refrigerator door handles are often prepared from TPE compositions and tend to attract and absorb such unwanted materials and become easily soiled. Recently, particularly with the popularity of white and off-white kitchens and appliances, soil resistance has become an increasingly desired property for such TPE compositions.

In addition to consumers themselves desiring this property, marketers and distributors of consumer applications do as well. Showroom appliances in particular become easily soiled due to the repeated touching of, e.g., refrigerator door handles by consumers, who each leave a bit of their own dirt, grease, and or oil. The same holds true for motorized vehicles on display to prospective buyers, where parts formed from TPEs are prone to attracting and absorbing soil. Not surprisingly, showroom floors are often the first place that consumers express distaste for a refrigerator or automobile having door handles that become easily soiled.

Soil resistance is an important property when TPEs are used for many applications, not just consumer applications. Thus, there is a need for improved TPEs that are able to resist becoming soiled when exposed to harsh environments.

### BRIEF SUMMARY OF THE INVENTION

Fulfilling a desired need, the present invention provides improved thermoplastic elastomer compositions—ones which are beneficially soil-resistant. The compositions comprise at least one elastomeric phase, at least one thermoplastic phase, and a minor amount of at least one low surface energy additive incorporated therein.

Also disclosed are improved articles based on the compositions and the use of at least one low surface energy additive for modifying a thermoplastic elastomer to improve its soil resistance.

### DETAILED DESCRIPTION OF THE INVENTION

### DEFINITIONS

As used herein, the identified terms have the following meanings identified unless specifically defined otherwise herein.

“Low surface energy additive” refers to a component having a lower surface energy than a composition to which it is added. Table 1 illustrates typical values in ascending order of surface energies of various individual materials.

TABLE 1

| Solid Material Surface | Surface Energy (dynes/cm) |
|---|---|
| Polyhexafluoropropylene | 16 |
| Polytetrafluoroethylene | 18-20 |
| Fluorinated ethylene propylene | 18-22 |
| Polytrifluoroethylene | 22 |
| Chlorotrifluoroethylene | 20-24 |
| Polydimethyl siloxane | 22-24 |
| Natural rubber | 24 |
| Paraffin | 23-25 |
| Polyvinylidene fluoride | 25 |
| Polyvinyl fluoride | 28 |
| Polypropylene | 29-31 |
| Polyethylene | 30-31 |
| Polychlorotrifluoroethylene | 31 |
| Polybutylene terephthalate | 32 |
| Nylon-11 (polyundecanamide) | 33 |
| Polystyrene, low ionomer | 33-35 |
| Polyacrylate | 35 |
| Tin-plated steel | 35 |
| Polyvinyl chloride, plasticized | 33-38 |
| Polyvinyl alcohol | 37 |
| Polystyrene, high ionomer | 37-38 |
| Polyphenylene sulfide | 38 |
| Polyvinyl chloride, rigid | 39 |
| Cellulose acetate | 39 |
| Polyvinylidene chloride | 40 |
| Polyimide | 40 |
| Polysulfone | 41 |
| Polymethylmethacrylate | 41 |
| Nylon-6 (polycaprolactam) | 42 |
| Polyethylene terephthalate | 41-44 |
| Cellulose (regenerated) | 44 |
| Copper | 44 |
| Aluminum | 45 |
| Iron | 46 |
| Nylon 6,6 (polyhexamethylene adipamide) | 46 |
| Polycarbonate | 46 |
| Glass, soda lime | 47 |
| Polyphenylene oxide | 47 |
| Styrene butadiene rubber | 48 |
| Polyethersulfone | 50 |

Unmodified TPE compositions, which do not include low surface energy additives according to the present invention, generally exhibit surface energies in the range of about 28 to about 35 dynes/cm. However, in order to have adequate soil resistance, TPE compositions of the invention preferably exhibit surface energies in the range of about 18 to about 25 dynes/cm upon modification of a base TPE with at least one low surface energy additive.

Surface energy is measurable via a wide variety of methods including well known surface tension and contact angle analysis. Surface tension analysis is also referred to as “dyne level” analysis. This method of analysis is widely used to test the surface features of plastics. The analysis is based on how varying solutions having known surface tensions act when applied to a non-absorptive surface such as many plastics.

In general, the ability of a substrate to anchor inks, coatings, or adhesives is directly related to its surface energy. If the substrate surface energy does not significantly exceed the surface tension of the fluid which is to cover it, wetting will be impeded and a poor bond will result. Accordingly, per this method, if a given solution wets the substrate surface after application, it is determined that the solution's dyne level (or surface tension) is lower than that of the substrate. If, instead, the given solution rapidly forms beads on the surface to which it is applied, it is determined that the solution's dyne level (or surface tension) exceeds that of the substrate. This method can be used to assess a material's surface energy in conjunction with the present invention.

An alternative method for surface tension analysis, one which is better suited than the dyne level method for use in commercial production, employs Accu Dyne Test™ Marker Pens (Diversified Enterprises; Claremont, N.H.). This test method is described in greater detail at the website for Tantec, Inc—www.accudynetest.com.

According to principles of contact angle analysis, the ability of a liquid to form a smooth, homogeneous surface when applied to a solid surface is dependent on the solid's surface energy. As a liquid is applied to solid surfaces of increasing surface energy, the angle of contact between the liquid's edge and the surface (i.e., the contact angle) decreases. Devices for measuring such a contact angle include a wide variety of contact angle meters. U.S. Pat. No. 5,268,733 describes one method and associated equipment for determination of contact angles for surface energy analysis. ASTM D5946 and TAPPI T565 pm-96 test methods also illustrate techniques for such analysis.

“Generally compatible” means that within a composition at least one phase (e.g., the elastomeric phase of a TPE) has good adhesion to and is finely dispersed in a continuous phase of another component (e.g., the thermoplastic phase of a TPE). While not meant to limit the scope of the invention, the average elastomer particle size in generally compatible TPE systems can range from as small as physically possible to about 100 μm in diameter. Desirably, the particle size of the elastomer particles can range from about 0.1 μm to about 5 μm in diameter, and preferably from about 0.05 μm to about 2 μm in diameter in particularly preferred compatible TPE systems.

“Minor amount” refers to the minimum amount required to impart desired properties to the compositions herein. Typically, however, minor amount is preferably about 0.1% to less than about 50% by weight based on total weight of the composition. More typically, a minor amount is preferably within the range of about 0.2% to about 20%, even more typically about 0.2% to about 10%, by weight based on total weight of the composition.

“Soil-resistant” compositions are those exhibiting resistance to becoming discolored through staining, scratching, scuffing or other degradation mechanisms. As noted above, TPE compositions exhibiting surface energies in the range of about 18 to about 25 dynes/cm are examples of compositions found to be soil-resistant according to the invention.

Often, a visual qualitative analysis can be used to determine whether a composition or articles therefrom are soil-resistant. When a quantitative assessment is desired, a modified version of ASTM D3206-92(2002), “Standard Test Method for Soil Resistance of Floor Polishes,” can be used to measure soil resistance of TPEs, both for analyzing compositions of this invention and for comparing those with other compositions. Many companies in the appliance industry and automotive industry have their own version of this test, which can be used for assessing applicability of compositions of the invention in those industries. The specific details of each individual test may vary, but what such tests have in common is that they can provide an assessment as to whether articles (e.g., an appliance part or an instrument panel of an automobile) formed from various compositions sufficiently withstand soiling for a particular industry application.

Thermoplastic Elastomer Compositions

Thermoplastic elastomer (TPE) compositions of the invention comprise at least one TPE and a minor amount of at least one low surface energy additive. The compositions comprise both of these components, before and after melt-processing, as the low surface energy additive typically does not chemically react with the TPE nor degrade during processing.

Thermoplastic Elastomer (TPE)

A wide variety of TPEs can be used beneficially with low surface energy additives of the invention. Within a TPE, there is at least one phase of a thermoplastic polymer and at least one phase of an elastomeric material, one of which is a continuous “matrix” phase in which the other phase is dispersed. Thus, depending upon the type of TPE, a thermoplastic polymer therein functions as either a continuous matrix phase or a discontinuous dispersed phase. As understood by those of ordinary skill in the art, which phase is the continuous phase depends upon the volume ratio of the thermoplastic to the elastomeric phase as well as the viscosity ratios of the materials comprising the two phases. The ratio of thermoplastic to elastomeric components in the TPE varies depending on the intended application. The selection of the types and amounts of these components is understood by those of ordinary skill in the art.

TPEs and compositions therefrom can include more than one continuous phase and/or more than one discontinuous phase. Thus, in further embodiments of the invention, the TPEs and compositions therefrom comprise at least two chemically distinct thermoplastic phases. In still further embodiments, the TPEs and TPE compositions therefrom comprise at least two chemically distinct elastomeric phases. Also within the scope of the invention are TPEs and TPE compositions comprising at least two chemically distinct thermoplastic phases and at least two chemically distinct elastomeric phases.

Elastomeric Component

Any suitable elastomer can form an elastomeric phase in TPEs of the invention. It is preferred that the elastomer has a substantially saturated hydrocarbon backbone chain that causes the copolymer to be relatively inert to ozone attack and oxidative degradation, but that the elastomer also has side-chain unsaturation available for curing.

Examples of useful elastomers include acrylic rubber, natural rubber, polyisoprene rubber, styrenic copolymer elastomers (i.e., those elastomers derived from styrene and at least one other monomer, elastomers that include styrene-butadiene (SB) rubber, styrene-ethylene-butadiene-styrene (SEBS) rubber, styrene-ethylene-propylene-styrene (SEPS) rubber, styrene-isoprene-styrene (SIS) rubber, styrene-ethylene-ethylene-propylene-styrene (SEEPS) rubber, styrene propylene-styrene (SPS) rubber, and others, all of which may optionally be hydrogenated), polybutadiene rubber, nitrile rubber, butyl rubber, ethylene-propylene-diene rubber (EPDM), ethylene-octene copolymers, halogenated versions of the foregoing (e.g., halo butyl), and other elastomers are non-limiting examples of useful elastomers according to the invention.

Particularly preferred are styrenic copolymer elastomers and olefinic elastomers. Most preferably, when EPDM comprises the elastomer phase of a TPE, the EPDM is crosslinked such that the TPE is a thermoplastic vulcanizate (TPV). Olefinic elastomers are especially useful in TPEs because of their reasonable cost for properties desired. Of these elastomers, EPDM is preferred because it is a fundamental building block in polymer science and engineering due to its low cost and high volume, as it is a commodity synthetic rubber since it is based on petrochemical production. EPDM encompasses copolymers of ethylene, propylene, and at least one nonconjugated diene.

Selection of an olefinic elastomer from commercial producers uses Mooney Viscosity properties. The Mooney Viscosity for olefinic elastomers can range from about 1 to about 1,000, and preferably from about 20 to about 150 ML 1+4@100° C. For EPDM, that Mooney Viscosity should be from about 1 to about 200, and preferably from about 20 to 70 ML 1+4@100° C., when the elastomer is extended with oil. Non-limiting examples of EPDM useful for the present invention are those commercially available from multinational companies such as Bayer Polymers, DuPont Dow Elastomers, Uniroyal Chemicals (now part of Crompton Corp.), ExxonMobil Chemicals, and others.

Many commercially available elastomers are prepared using processing oils. In certain TPEs, the presence of organic oils, oils which are typically used for processing in this manner, increases the tendency of a composition to attract and absorb unwanted residue (e.g., dirt and oil) from the environment in which articles made from the composition are used. Therefore, it is particularly preferred to use grades of elastomers that are essentially oil-free. For example, NORDEL MG is an oil-free series of black EPDM available from DuPont Dow Elastomers in flake form, but with carbon black. NORDEL IP is another oil-free series of white EPDM available from DuPont Dow Elastomers in pellet form. While both these oil-free series available from DuPont Dow Elastomers are manufactured using metallocene-type catalysts, those manufactured using traditional vanadium-based catalysts can also be used in this invention.

The elastomer itself may be provided in a variety of forms. For example, elastomers are available in liquid, powder, bale, shredded, or pelleted form. The form in which the elastomer is supplied influences the type of processing equipment and parameters needed to form the TPE. Those of ordinary skill in the art are readily familiar with processing elastomers in these various forms and will make the appropriate selections to arrive at the TPE component of the invention.

Thermoplastic Component

Thermoplastics are generally materials that can be molded or otherwise shaped and reprocessed at temperatures at least as great as their softening or melting point. Polyolefins are preferred thermoplastic materials. As such, one particularly preferred TPE is a thermoplastic olefin elastomer (TPE-O). TPE-Os comprise at least one thermoplastic polyolefin and at least one elastomer.

Polyolefins, like olefinic elastomers, are a fundamental building block in polymer science and engineering because of their low cost, high volume production based on petrochemical production. Non-limiting examples of polyolefins useful as thermoplastic olefins of the invention include homopolymers and copolymers of lower α-olefins such as 1-butene, 1-pentene, 1-hexene, 2-methyl-1-propene, 3-methyl-1-pentene, 4-methyl-1-pentene, and 5-methyl-1-hexene, as well as ethylene, butylene, and propylene, with the homopolymer of propylene and copolymers of propylene being preferred. Most preferred is the homopolymer of propylene, polypropylene.

Polypropylene (PP) has thermoplastic properties best explained by a recitation of the following mechanical and physical properties: a rigid semi-crystalline polymer with a modulus of about 1 GPa, a yield stress of about 35 MPa, and an elongation to ranging from about 10% to about 1,000%. Selection of a polyolefin from commercial producers uses Melt Flow Index or Melt Flow Rate (MFI or MFR) properties. The MFI can range from about 0.05 to about 1400, and preferably from about 0.5 to about 70 g/10 min at 230° C. under a 2.16 kg load. For polypropylene, that MFI should be from about 0.5 to about 70 and preferably from about 1 to about 35 g/10 min at 230° C. under a 2.16 kg load. Non-limiting examples of polypropylene useful for the present invention are those commercially available from multinational suppliers such as Dow Chemicals, Basell Polyolefins, and BP Amoco, Chevron-Phillips Chemical Co., Huntsman, et cetera.

Preferably the thermoplastic and elastomeric components of the TPE are selected such that they are generally compatible. However, as noted above and unless proscribed otherwise by the appended claims, formation -of TPE compositions comprising at least one low surface energy additive are not necessarily limited to those based on any particular TPE and a wide variety of TPEs are commercially available. For example, Polyone Corporation, Bayer, Crompton Corporation, DuPont Dow Elastomers, Teknor Apex, AES, Multibase, So.F.Ter., S.p.A., Sumitomo, Asahi Kasei, Kraton, Solvay, GLS, ExxonMobil Corporation, Uniroyal Chemical, and many other multinational companies have supplied commercial TPEs to the marketplace under an assortment of trade designations. These companies and many others provide a wide variety of TPEs that can be used in accordance with the present invention.

Low Surface Energy Additive

TPE compositions of the invention include a minor amount of at least one low surface energy additive in an amount effective to render the TPE composition soil-resistant. The type of low surface energy additive used is influenced by the type of soil for which improved resistance is desired.

The low surface energy additive can be based on any suitable chemistry. For example, many low surface energy additives comprise fluorine-containing and/or silicon-containing polymers. Preferably, the low surface energy additive comprises a silicon-based material. Silicon-based materials are resistant to a wide variety of different types of soil.

Examples of silicon-based low surface energy additives useful in compositions of the invention include silanes and silicone oil (as opposed to organic oils). Preferably, the low surface energy additive or combinations thereof comprise silanes.

Examples of suitable silanes include methyltrimethoxysilane, methyltriethoxysilane, methyltriisopropoxyoxysilane, ethyltrimethoxysilane, ethyltriethoxysilane, propyltrimethoxysilane, isobutyltrimethoxysilane, isobutyltriethoxysilane, 2-ethylbutyltriethoxysilane, tetraethoxysilane, mercaptopropyltrimethoxysilane, and 2-ethylbutoxytriethoxysilane. Further examples of suitable silanes include silane-grafted polyolefins such as those available under trade designations of SYNCURE from PolyOne Corporation (Avon Lake, Ohio), SIOPLAS from Solvay Padanaplast (Roccabianca, Italy), and FORLINK from So.F.Ter. S.p.A. (Forli, Italy).

The amount of low surface energy additive used is also influenced by the type of soil for which improved resistance is desired. Generally, however, a minor amount of at least one low surface energy additive is used to impart soil resistance to improved TPEs of the invention. While more than a mere minor amount of low surface energy additives may be used, it is generally beneficial from a pure cost basis to use only a minor amount. Low surface energy additives tend to be more expensive than base TPEs to which they are added.

Optional Components

Additives, or further additives as compared to those in the base TPE, can be optionally included in the TPE compositions of the invention, if desired. The type and amount of additives so used will depend on the presence and amount of additives in the base TPE, which in large part depends on the source of that TPE. The type and amount of additives used will also depend on the desired application for which the end user will prepare articles from the TPE composition.

In any event, so long as it does not prevent obtaining an improvement in soil resistance of the TPE, any suitable additive may be included in desired amounts in TPE compositions of the invention. For example, processing oils, compatibilizers, fillers (e.g., calcined clay, kaolin clay, nanoclay, talc, silicates, and carbonates), pigments and colorants (e.g., carbon black), flame retardants, antioxidants, conductive particles, UV-inhibitors, stabilizers, coupling agents, plasticizers, lubricants, antiblocking agents, antistatic agents, waxes, foaming agents, and combinations thereof may be beneficially used in certain applications. Those of ordinary skill in the art will readily understand selection and use of such additives.

For instance, the use of processing oils to effect oil extension of the elastomer is well known in the art. In the production of TPEs, for example, it is often desirable to include an oil to extend the elastomer portion of the composition. This oil extension provides the property of lower hardness, while reducing cost of the elastomer to achieve the same TPE volume.

Oil can be a separate ingredient in the TPE composition or can be a part of the base elastomer itself, depending on the source of TPE. Non-limiting examples of oils that could be optionally used in the present invention include aromatic, paraffinic, and napthathenic mineral oils. Both fully saturated oils as well as partially unsaturated oils are usable depending upon the particular end-use application and the type of elastomer selected for the formulation of the TPE.

It is preferred for maximum soil resistance, however, that the compositions are essentially free of organic processing oils. As noted above, the general purpose for using processing oils when preparing TPEs is to extend the elastomeric component of TPEs (which is generally the more expensive component of the TPE as compared to the thermoplastic component) in an effort to reduce the overall cost of the composition. The use of organic oils, however, oils which are typically used for processing in this manner, increases the tendency of a composition to attract and absorb unwanted residue which often tends to be organic itself (e.g., dirt and oil).

Certain types of TPEs absorb organic oils more readily than others. When the TPE has a tendency to absorb oil (e.g., as is the case with EPDM and SEBS), preferably the composition contains less than about 10% by weight organic processing oil based on total weight of the composition. When the TPE does not generally absorb oil (e.g., ENGAGE-brand TPEs available from DuPont Dow Elastomers (Wilmington, Del.)), it is preferred that essentially no organic processing oil is used in conjunction therewith (i.e., the compositions are organic oil-free).

While processing oils may enable extension of an elastomeric component's properties throughout the composition for overall cost savings, it often makes the TPE and compositions therefrom ineffective for use in the intended applications that require soil resistance. Further, the use of processing oils may also be otherwise unnecessary for preparation of those articles.

For example, the use of processing oils and plasticizers is not necessarily beneficial in applications where enhanced soil resistance is needed because of the desired topography of articles used in those applications. One noteworthy example is the handle on many conventional refrigerators, which handle has a relatively rough surface to facilitate better gripping of the handle by a consumer. The use of processing oils and plasticizers tends to impart smoother surfaces to articles prepared from the resulting compositions and, as such, their use is further undesirable in those particular applications.

One alternative to the use of processing oils when cost-efficient extending of elastomeric properties throughout a TPE is desired involves the addition of fillers such as talc, calcium carbonate, or clay, for example, to the composition. It has been found that the use of such fillers in certain TPE chemistries, such as those based on EPDM and PP, often provides an effective alternative to use of processing oils for obtainment of desired properties.

Another optional component in TPE compositions of the invention is a compatibilizer. The use of compatibilizers to promote integration of, for example, the discrete elastomer phase into the continuous thermoplastic phase (or vice versa) of a TPE is well known. In the production of TPEs, for example, it is often desirable and advantageous to include a compatibilizer to promote synergistic integration of the two distinct components—the thermoplastic and elastomer—when attempting to provide certain improved performance properties as compared to those observed with either component alone.

Preparation of Thermoplastic Elastomer (TPE) Compositions

Selection of Components

TPE compositions of the invention include at least one TPE and a minor amount of at least one low surface energy additive. Optionally, the TPE composition may include other additives, such as those noted above. The components of the overall composition are selected such that the desired level of soil resistance is obtained, which level often depends on the application for which the compositions are used.

Selection of Processing Equipment and Processing of the TPE Composition

The introduction of the low surface energy additive into the TPE compositions of the present invention is not complicated and can utilize any one of several methods: (1) addition during formation of the TPE itself, (2) addition as a post-processing step after the TPE itself is formed but before the TPE is transferred to another melt-processor (e.g., the end user who will transform the TPE composition into a desired article), or (3) addition during final processing of the TPE into a part or article. The third method is generally not preferred, not only because the end user typically desires to maximum their process efficiency, but also due to the possibility of the low surface energy additive not being sufficiently dispersed within the TPE, resulting in non-uniform and unpredictable results.

The first method of adding the low surface energy additive during formation of the TPE provides an in-situ formed TPE composition of the invention. According to this method, thermoplastic and elastomer components of at least one TPE are provided. At least one low surface energy additive is then combined with the components of the TPE. These components are then mixed, optionally in the presence of one or more optional additives. While not necessary, the components can also be heated in a further embodiment so that the thermoplastic phase of the TPE softens or melts (without requiring that the low surface energy additive softens or melts). In this further embodiment, the low surface energy additive is able to substantially disperse within at least one thermoplastic phase of the TPE during formation of the TPE itself. Formation of the TPE in this first method uses steps well familiar to those of ordinary skill in the art.

The second method for preparing a TPE composition incorporates at least one low surface energy additive into at least one base TPE that has already been formed. According to this method, at least one base TPE is provided. At least one low surface energy additive is then combined with the TPE. These components are then mixed, optionally in the presence of one or more optional additives. While not necessary, the components can also be heated in a further embodiment so that the thermoplastic phase of the TPE softens or melts (without requiring that the low surface energy additive softens or melts). In this further embodiment, the low surface energy additive is able to substantially disperse within at least one thermoplastic phase of the TPE.

For either of these methods, processing of the TPE composition can occur via batch or continuous processing. Using either batch or continuous processing, components of the TPE composition can be mixed and heated to disperse the low surface energy additive in the thermoplastic phase of the TPE in either a single piece of equipment or in multiple pieces of equipment. Economies of scale for production lead to a preference for continuous processing. Further economies of scale can be obtained when further steps are continuously performed. For example, a particularly efficient process is one whereby the TPE compositions can be formed into desired shapes and sizes continuously with their preparation.

In one embodiment of a batch process, TPE compositions can be prepared by mixing the components in a first piece of equipment. Mechanical mixers, such as Banbury-type, Brabender-type, roll mill, Buss, dry turbo mixers and the like are suitable for this purpose.

In one embodiment, all base components (i.e., TPE or components thereof, low surface energy additive, and other optional additives, if used) of the TPE composition can be charged into the mixer. Mixing proceeds at any suitable pace to preferably effect a substantial mixing of the components. For example, mixing proceeds at a pace ranging from about 10 to about 100 rpm (revolutions per minute), and preferably from about 75 to about 85 rpm for a duration ranging from about 1 to about 5 minutes, and preferably from about 2 to about 4 minutes in certain embodiments of the invention.

If dispersion of the low surface energy additive into the thermoplastic phase of the TPE is desired, heat can also be applied during this mixing step. When heat is applied, it is applied at a temperature sufficient to achieve the desired effects. Preferably, the components are heated to a temperature sufficient to melt or soften the thermoplastic component of the TPE (melting or softening of the low surface energy additive is not required). For example, when the thermoplastic phase of the TPE comprises a propylene-based polymer, the components are typically heated to a temperature ranging from about 170° C. to about 210° C., and preferably from about 185° C. to about 195° C.

In a batch process, the TPE composition is then transferred to other equipment for formation into the desired shape and size. Typically, this will be a shape and size that enables an end user to melt process the TPE composition into the desired article. For example, plugs of the TPE composition can be removed from the mixer and compression-molded into, for example, a 7.6 cm×15.2 cm×0.31 cm (3 in×6 in×0.125 in) plaque mold at a temperature ranging from about 170° C. to about 230° C., and preferably from about 195° C. to about 215° C. The plug material can be held under, for example, no pressure for about 30 seconds, after which pressure can be increased to about 1,100 kN force over a period of about 3 minutes. After application of pressure of about 1,100 kN force for about 4 minutes, the samples can be cooled to ambient temperature while pressure is maintained.

During continuous processing, the components can be first mixed in a suitable mixer. Mechanical mixers, such as Banbury-type, Brabender-type, roll mill, Buss, dry turbo mixers and the like are suitable for this purpose. Sufficient heat is generally generated in these mixers to melt mix the low surface energy additive into the TPE composition. In this embodiment, the mixed components are then conveyed continuously to another piece of equipment, where the mixture is heated to form the TPE composition. Processing then continues by forming the TPE composition into the desired shape and size without the need to transfer the bulk contents to another piece of equipment during the continuous process. The TPE can even be formed into the end-use article, if desired, using continuous processing.

An example of a continuous process for forming the TPE composition comprises utilization of reactive extrusion equipment. A wide variety of reactive extrusion equipment can be employed in this manner. Preferred is a twin screw co-rotating extruder with a length-to-diameter (L/D) ratio ranging from about 38 to about 60, and preferably from about 40 to about 52.

Reactive extrusion allows for dynamic vulcanization of the elastomer phase of the TPE to occur, which is preferably when preparing thermoplastic vulcanizates (TPVs). Dynamic vulcanization, when used in conjunction with the present invention, can advantageously further reduce processing time and throughput. However, methods other than dynamic vulcanization can be utilized to prepare TPE compositions of the invention. For example, the elastomer component of the TPE can be cured in the absence of the thermoplastic component, powdered, and mixed with the thennoplastic component at a temperature above the melting or softening point of the thermoplastic component to form a TPE.

While optional, a TPE may be fully or partially crosslinked. As noted above, in certain embodiments of the invention, it is preferred that the TPE composition be a partially or fully crosslinked TPV. To achieve reaction, and hence crosslinking (also referred to as “curing”) of a TPE so that it becomes a TPV, the mixture is typically heated to a temperature substantially equal to or greater than the softening or melting point of any thermoplastic component of the TPE and for a sufficient time to obtain a composition of the desired homogeneity and crosslinking of the elastomer phase. For example, the extrusion profile for a preferred polypropylene (PP)/EPDM reactive extrusion can be a flat 190° C. profile and 500 rpm. The reaction components can be fed into the reaction extruder at 27 kg/hr (60 lbs/hr) using, for example, a 25-mm twin screw extruder.

The components of the TPE composition may be added to the processing equipment in any suitable amount and in any suitable order. As noted above, the low surface energy additive can be added before or after formation of the base TPE. Those of ordinary skill in the art will readily recognize the ability to vary the amount and order of addition of the components within the TPE composition in general.

Usefulness of the Invention

TPE compositions of the invention can be formed into a variety of articles as well understood by those of ordinary skill in the art. For example, TPE compositions can be reprocessed, such as by being pressed, compression-molded, injection-molded, calendared, thermoformed, blow-molded, or extruded into final articles. When reprocessing TPE compositions of the invention, the composition is generally heated to a temperature of at least the softening or melting point of the thermoplastic component of the TPE composition in order to facilitate further forming into desired articles of various shapes and sizes. The end user of the TPE compositions will benefit by the processing advantages described throughout.

Further, the present invention promotes the end user's ability to enhance soil resistance of certain articles formed from the TPE compositions. Beneficially, improved TPE compositions of the invention are particularly useful for forming surfaces or portions thereof that are adapted for repeated contact with a soiled surface. For example, handles on consumer appliances (e.g., refrigerator door handles) and automobile parts are such surfaces as discussed above.

### EXAMPLES

Exemplary implementations of the invention are described in the following non-limiting prophetic examples.

Examples 1-6 and Comparative Examples C1-C3

Table 2 provides examples of formulations preparable according to the present invention (Examples 1-6) as compared to other formulations (Comparative Examples C1-C3). In Table 2, the individual components in each formulation are listed, as well as their source of supply and the amount of each by weight. Formulations of the invention are soil-resistant, while those of Comparative Examples C1-C3, which do not comprise a low surface energy additive, are not soil-resistant according to the invention.

TABLE 2

| | | Parts by Weight | | | | | | | | |
|---|---|---|---|---|---|---|---|---|---|---|
| Component | | Ex. | Ex. | Ex. | Ex. | Ex. | Ex. | Ex. | Ex. | Ex. |
| (Trade Designation) | Supplier | C1 | 1 | 2 | C2 | 3 | 4 | C3 | 5 | 6 |
| Polypropylene | Basell; | 40 | 40 | 40 | 30 | 30 | 30 | — | — | — |
| homopolymer, 1 MFR | Elkton, MD | | | | | | | | | |
| (Pro-fax ™ 6823) | | | | | | | | | | |
| EPDM | DuPont Dow | 60 | 60 | 60 | — | — | — | — | — | — |
| (Nordel ™ IP 4770P) | Elastomers, | | | | | | | | | |
| | L.L.C.; | | | | | | | | | |
| | Wilmington, DE | | | | | | | | | |
| Silane-grafted polyolefin | PolyOne Corp.; | — | 5 | — | — | 10 | — | — | 10 | — |
| (Syncure ™ S1054A) | Avon Lake, OH | | | | | | | | | |
| Ultra high molecular | Dow Corning; | — | — | 2 | — | 0.1 | 1 | — | — | 3 |
| weight siloxane polymer | Midland, MI | | | | | | | | | |
| dispersed in | | | | | | | | | | |
| polypropylene | | | | | | | | | | |
| homopolymer | | | | | | | | | | |
| (Dow Corning ™ MB50- | | | | | | | | | | |
| 001 Masterbatch) | | | | | | | | | | |
| SEBS, linear (Kraton ™ | Kraton Polymers; | — | — | — | 70 | 70 | 70 | — | — | — |
| G-1652) | Houston, TX | | | | | | | | | |
| TPE having a polyolefin | PolyOne Corp.; | — | — | — | — | — | — | 100 | 100 | 100 |
| phase with a crosslinked | Avon Lake, OH | | | | | | | | | |
| EPDM phase dispersed | | | | | | | | | | |
| therein | | | | | | | | | | |
| (Forprene ™ 6E0 901 | | | | | | | | | | |
| A70) | | | | | | | | | | |

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited.

1. A thermoplastic elastomer composition comprising:
at least one elastomeric phase;
at least one thermoplastic phase; and
a minor amount of at least one low surface energy additive incorporated therein,
wherein the composition is soil-resistant.

2. The thermoplastic elastomer composition of claim 1, wherein the composition has a surface energy of about 18 dynes/cm to about 25 dynes/cm and wherein the elastomeric phase is derived from at least one styrenic or olefinic elastomer.

3. The thermoplastic elastomer composition of claim 1, wherein the elastomeric phase comprises ethylene-propylene-diene rubber, wherein the thermoplastic phase is derived from at least one olefin, and wherein the low surface energy additive comprises a polymer containing at least one of fluorine or silicon.

4. The thermoplastic elastomer composition of claim 4, wherein the low surface energy additive comprises a silicon-based material selected from the group consisting of silicone oil, a silane, a silane-grafted polyolefin, methyltrimethoxysilane, methyltriethoxysilane, methyltriisopropoxyoxysilane, ethyltrimethoxysilane, ethyltriethoxysilane, propyltrimethoxysilane, isobutyltrimethoxysilane, isobutyltriethoxysilane, 2-ethylbutyltriethoxysilane, tetraethoxysilane, mercaptopropyltrimethoxysilane, 2-ethylbutoxytriethoxysilane, and combinations thereof.

5. The thermoplastic elastomer composition of claim 1, wherein the composition is essentially free of organic oil.

6. An article prepared from the thermoplastic elastomer composition of claim 1.

7. The article of claim 6, wherein the article comprises at least one surface or portion thereof adapted for repeated contact with a soiled surface.

8. The article of claim 7, wherein the surface or portion thereof comprises a matte topography.

9. The article of claim 7, wherein the article comprises a consumer appliance or motorized vehicle.

10. A method of using at least one low surface energy additive for modifying a thermoplastic elastomer to improve its soil resistance, comprising incorporating a minor amount of the at least one low surface energy additive into the thermoplastic elastomer to form a thermoplastic elastomer composition having improved soil resistance as compared to the unmodified thermoplastic elastomer.
